(19) United States
(12) Patent Application Publication
(10) Pub. No.: US 2026/0082088 A1
(43) Pub. Date: Mar. 19, 2026

(54) IMAGE ENCODING BASED ON INTER CHANNEL PREDICTION OF ENTROPY PARAMETERS

(71) Applicant: HUAWEI TECHNOLOGIES CO., LTD., Shenzhen (CN)

(72) Inventors: Alexander Andreevich PLETNEV, Moscow (RU); Alexey Kolosov, Moscow (RU); Jue Mao, Hangzhou (CN); Alexander Alexandrovich Karabutov, Munich (DE); Timofey Mikhailovich Solovyev, Munich (DE); Maxim Borisovitch Sychev, Moscow (RU); Alexey Aleksandrovich Letunovskiy, Moscow (RU); Denis Vladimirovich Parkhomenko, Moscow (RU); Sergey Yurievich Ikonin, Moscow (RU); Xiang Ma, Shanghai (CN); Yin Zhao, Hangzhou (CN)

(73) Assignee: HUAWEI TECHNOLOGIES CO., LTD., Shenzhen (CN)

(21) Appl. No.: 19/397,008

(22) Filed: Nov. 21, 2025

Related U.S. Application Data
(63) Continuation of application No. PCT/RU2023/000152, filed on May 26, 2023.

(51) Int. Cl. H04N 19/91; H04N 19/124

(52) U.S. Cl. CPC H04N 19/91; H04N 19/124

(57) ABSTRACT

Embodiments of the present disclosure relate to methods, devices, apparatuses, and program products for image encoding and decoding. An example method comprises: dividing an image into a plurality of channels; encoding a first channel of the plurality of channels based on entropy encoding; obtaining a first entropy parameter for the first channel; determining a second entropy parameter for a second channel of the plurality of the channels based on the first entropy parameter; and encoding the second channel based on the second entropy parameter. The embodiments of the present disclosure can significantly accelerate decoding of images.

### CROSS-REFERENCE TO RELATED APPLICATIONS

This application is a continuation of International Application No. PCT/RU2023/000152, filed on May 26, 2023, the disclosure of which is hereby incorporated by reference in its entirety.

### FIELD

Embodiments of the present disclosure generally relate to the field of computer technology and in particular, to methods, devices, an apparatuses, and computer program products for image encoding based on inter channel prediction of entropy parameters.

### BACKGROUND

The past decade has witnessed great success of deep learning technologies in many disciplines, especially in computer vision and image processing. Recently, there are a lot of attempts to apply deep-learning to data compression, for example, image compression, also some other data compression, like the video data compression, 3D data (like point-cloud data) compression, and so on. Existing image compression approaches with deep-learning are typically time consuming, in particular, at the decoding stage. There is need for further improved image compression with accelerated decoding.

### SUMMARY

In general, embodiments of the present disclosure provide solutions for image encoding and decoding.

In a first aspect, there is provided a method for encoding an image. The method comprises: dividing an image into a plurality of channels; encoding a first channel of the plurality of channels based on entropy encoding; obtaining a first entropy parameter for the first channel; determining a second entropy parameter for a second channel of the plurality of the channels based on the first entropy parameter; and encoding the second channel based on the second entropy parameter. In this way, an image is converted to channels and encoded based on inter-channel prediction of entropy parameters for the channels. Compared with legacy pixel-wised methods, the proposed channel-wised encoding method removes time-consuming autoregression for a large number of pixels and thus enables accelerated decoding of the image.

In a second aspect, there is provided a method for decoding an image. The comprises: decoding a first channel of a plurality of channels of an image based on entropy decoding; obtaining a first entropy parameter for the first channel based on the decoded first channel; determining a second entropy parameter of a second channel for the plurality of the channels based on the first entropy parameter; and decoding the second channel based on the second entropy parameter. Compared with legacy pixel-wise methods, the proposed channel-wised decoding method requires much lower decoding time. For example, assuming an image has a size of W*H (W is width, His height), the amount of decoding time of a pixel-wised method would be TP*W*H (TP is time of decoding one pixel). And the amount of decoding time of the proposed method would be TC*C (TC is time of decoding one channel, and C is the number of channel of the image). Note that the number of channels (C) is far less than the number of pixels (W*H) and decoding time of one symbol (TC and TP) are close. Thus, for a given image, the proposed channel-wised decoding method may achieve a significantly reduced decoding time compared with pixel-wised methods.

In a third aspect, there is provided an electronic device. The electronic device comprises a processor and a memory coupled to the processor, wherein the memory has instructions stored therein which, when executed by the processor, cause the device to perform actions. The actions comprise: dividing an image into a plurality of channels; encoding a first channel of the plurality of channels based on entropy encoding; obtaining a first entropy parameter for the first channel; determining a second entropy parameter for a second channel of the plurality of the channels based on the first entropy parameter; and encoding the second channel based on the second entropy parameter.

In a fourth aspect, there is provided an electronic device. The electronic device comprises a processor and a memory coupled to the processor, wherein the memory has instructions stored therein which, when executed by the processor, cause the device to perform actions. The actions comprise: decoding a first channel of a plurality of channels of an image based on entropy decoding; obtaining a first entropy parameter for the first channel based on the decoded first channel; determining a second entropy parameter of a second channel for the plurality of the channels based on the first entropy parameter; and decoding the second channel based on the second entropy parameter.

In a fifth aspect, there is provided an apparatus. The apparatus comprises: means for dividing an image into a plurality of channels; means for encoding a first channel of the plurality of channels based on entropy encoding; means for obtaining a first entropy parameter for the first channel; means for determining a second entropy parameter for a second channel of the plurality of the channels based on the first entropy parameter; and means for encoding the second channel based on the second entropy parameter.

In a sixth aspect, there is provided an apparatus. The apparatus comprises: means for decoding a first channel of a plurality of channels of an image based on entropy decoding; means for obtaining a first entropy parameter for the first channel based on the decoded first channel; means for determining a second entropy parameter of a second channel for the plurality of the channels based on the first entropy parameter; and means for decoding the second channel based on the second entropy parameter.

In a seventh aspect, there is provided a computer program product stored on a computer-readable medium and comprising machine-executable instructions, wherein the machine-executable instructions, when executed, cause a machine to perform the method according to the first aspect or the second aspect of the present disclosure.

In an eighth aspect, there is provided a computer-readable medium comprising machine-executable instructions, wherein the machine-executable instructions, when executed, cause a machine to perform the method according to the first aspect or the second aspect of the present disclosure.

In an eighth aspect, there is provided bitstream. The bitstream comprises encoded data of a first channel, wherein the first channel is one of a plurality of channels of an image; and encoded data of a second channel of the plurality of channels, wherein the first channel is encoded based on first entropy parameter, and the second channel is encoded based on second entropy parameter, wherein the second entropy parameter is determined based on the first entropy parameter.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, where:

FIG. 1 illustrates a schematic diagram of an example environment in which a plurality of embodiments of the present disclosure can be implemented;

FIG. 2 illustrates a flowchart of an example method for encoding an image according to some embodiments of the present disclosure;

FIG. 3 illustrates a flowchart of an example method for decoding an image according to some embodiments of the present disclosure;

FIG. 4 illustrates a flowchart of another example method for encoding an image according to some embodiments of the present disclosure;

FIG. 5 illustrates a flowchart of another example method for decoding an image according to some embodiments of the present disclosure;

FIG. 6A illustrates a schematic diagram of an example neutral network for determining entropy parameters from a quantized channel according to some embodiments of the present disclosure;

FIG. 6B illustrates a schematic diagram of an example neutral network for inter-channel prediction of entropy parameters according to some embodiments of the present disclosure;

FIG. 7 illustrates a schematic diagram of an example decoding flow according to some embodiments of the present disclosure;

FIG. 8A illustrates an example wavelet transform for an image according to some embodiments of the present disclosure;

FIG. 8B illustrates an example decomposition of an image based on the wavelet transform as shown in FIG. 8A according to some embodiments of the present disclosure;

FIG. 9 illustrates a schematic diagram of another example decoding flow according to some embodiments of the present disclosure.

Throughout all the drawings, the same or similar reference numerals represent the same or similar elements.

### DETAILED DESCRIPTION

The principle of the present disclosure will now be described with reference to some embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of the ordinary skills in the art to which this disclosure belongs.

References in the present disclosure to “one embodiment,” “some embodiments,” “an embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some embodiments, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of embodiments. As used herein, the term “and/or” includes any and all combinations of one or more of the listed terms.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or the same objects. Other definitions, explicit and implicit, may be included below. It is to be explained that any numerical values or numbers used in the disclosure are examples only and shall not restrict the scope of the disclosure.

The terminology used herein is for the purpose of describing particular embodiments only and is not intended to be limiting to embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, etc., but do not preclude the presence or addition of one or more other features, elements, components and/or combinations thereof.

For better understanding embodiments of the disclosure, provided below is definitions of terms that are related to the disclosure.
Picture size refers to the width w or height h or the width-height pair of a picture. Width and height of an image is usually measured in number of luma samples.
Entropy encoding refers to any lossless data compression method that attempts to approach the lower bound declared by Shannon's source coding theorem in information theory, which states that any lossless data compression method must have expected code length greater or equal to the entropy of the source. Generally, source data that occurs more frequently has a shorter code length, and vice versa. The knowledge of distribution of source data is essential for compression efficiency of entropy encoding.
Neural Network refers to computing systems vaguely inspired by the biological neural networks that constitute animal brains. Any neural network can be formalized and fully defined as a directed acyclic graph with set of nodesZ. Each node z^{(k)} represents a tensor (multi-dimensional array) and associated with an operation (neural network layer) o^{(k)}∈O on a set of its parent nodes I^{(k)}. Only exception is input node x which doesn't have input nodes and associated operations. Computations at node k is represented as z^{(k)}=o^{(k)}(I^{(k)}. Set of operations O includes unary operations (convolutions, pooling, activations, batchnorms, etc.) and multivariate operations (concatenation, addition, etc.). Any representation that specifies a set of parents and an operation of each node completely defines a neural network.
Training is the adaptation of the network to better handle a task by considering sample observations. Training involves adjusting the weights and other parameters of the network to improve the accuracy of the result. This is done by minimizing the observed errors. After finish of the training, neural network with adapted weights called trained neural network.
Loss function is a function that maps values of one or more variables onto a real number intuitively representing some “cost” associated with the observed variables. For example, if we consider values of errors on multi-dimensional array (for example image), then a loss function could be MeanSquareError (MSE)-average of the squares of the errors
Backpropagation is a method to adjust the weights to compensate for each error found during learning. Technically, backpropagation calculates the gradient (the derivative) of the cost function associated with a given state with respect to the weights. The weight updates can be done via stochastic gradient descent (SGD) or other methods.
Wavelet transform is a mathematical technique which can decompose a signal into multiple lower resolution layers by controlling the scaling and shifting.
Layer is level of transpose operation. For example, wavelet transform has several layers which divided into subbands.
Channel is independent part of layer (layer divides by several channels). For example in wavelet transform subband is a channel. Another example is channel(s) in neural network convolution2d module.

The past decade has witnessed great success of deep learning technologies in many disciplines, especially in computer vision and image processing. Recently, there are a lot of attempts to apply deep-learning to data compression (like image compression, also some other data compression, like the video data compression, 3D data (like point-cloud data) compression, and so on). For example, for image compression, there are a lot of attempts to use neural networks to enhance or even replace some modules in the traditional video codec architecture, for example, deep learning based intra prediction, inter prediction and entropy coding.

In the traditional intra prediction, the neighboring reconstructed samples of a coding block are used to get the prediction of the samples inside the coding block along a specific straight direction (or some fixed pattern) which is indicated by an intra prediction mode. With the deep learning with the reference samples, the generated prediction sample value could be more flexible, and could be more similar with the samples inside the current coding block.

In the traditional inter prediction, the reference block in a reference picture are used to get the prediction of the samples inside the current coding block, by using a simple weighting method. By using deep learning with the reference blocks, more flexible predictions can be obtained, which could be more similar with the samples inside the current coding block.

In the traditional entropy coding, some neighboring information or priori knowledge are used as context, which will be used to estimate the probability of a syntax value for arithmetic coding. By using deep learning with context, more accurate probability could be estimated.

Also, there is another important attempt using the deep learning technology to reduce or even remove the coding artifacts to enhance the quality (objective quality or subjective quality) of the decoded pictures. Neural network (e.g. convolution neural network, CNN) based enhancement filters are most common deep-learning techniques applied in compression, like the image compression.

As mentioned, there are a lot of approaches of applying machine learning methods for image compression subject field. A general practice is to train autoregression model to predict entropy parameters on a pixel-wise level. The disadvantage of this approach is the computational and temporal complexity of implementing autoregression. Since sequential decoding of pixels is necessary, and massive parallelism feature of neural network based processing methods cannot be fully used.

In view of this, there is proposed a channel-wise approach for image compression. Difference between pixel-wise and channel-wise approach is that unit of prediction is pixel or channel respectively. In some embodiments, it can be organized as intra layer or inter layer mode. Difference between intra layer and inter layer modes in channel-wise approach is that in intra layer input and output belong to channels from same layer and in inter layer input and output belong to channels from different layers.

The proposed channel-wised method outperforms baseline pixel-wised method. The presented method can remove pixel-wised autoregression, simplify decoder scheme and accelerates decoding compared with pixel-wised method. This methodology could be used generally for channel-based solutions and in particular for wavelets subband-based solution.

In an example method for encoding, a device divides an image into a plurality of channels. For example, the device may perform image transform to convert the image from pixel values to channels with coefficients. The device encodes a first channel of the channels based on entropy encoding. The device obtains a first entropy parameter for the first channel. The device further determines entropy parameters for the remaining channels based on the first entropy parameter for the first channel. The device encodes the remaining channels based on respective entropy parameters for the channels. The encoded channels may be transmitted to a bitstream.

In an example method for decoding, a device decodes, for example, from a bitstream, a first channel of a plurality of channels of an image based on entropy decoding. The device obtains a first entropy parameter for the first channel based on the decoded first channel. The device further determines entropy parameters of the remaining channels based on the first entropy parameter. The device decodes the remaining channels based on respective entropy parameters for the channels. The decoded channels may comprise coefficients of channels and may be inversely transformed to obtain a reconstructed image.

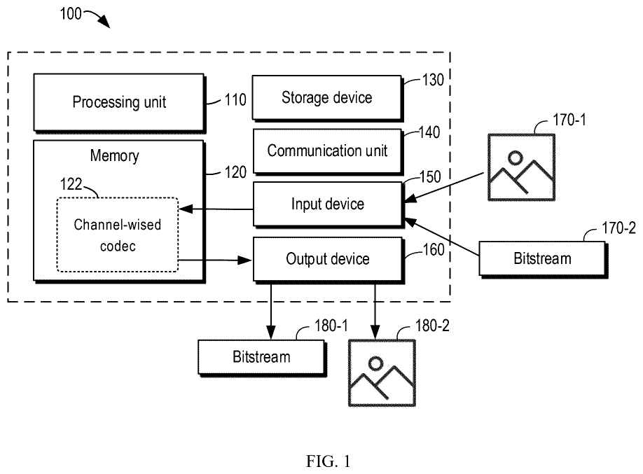

Principles and embodiments of the present disclosure will be described in detail below with reference to the accompanying drawings. Reference is first made to FIG. 1, which illustrates a schematic diagram of an example environment 100 in which a plurality of embodiments of the present disclosure can be implemented.

FIG. 1 illustrates a block diagram of a computing device 100 in which embodiments of the disclosure can be implemented. It should be understood that the computing device 100 shown in FIG. 1 is only exemplary and does not limit the functions and scopes of the embodiments described by the disclosure. According to FIG. 1, components of the computing device 100 can include, but not limited to, one or more processors or processing units 110, a memory 120, a storage device 130, one or more communication units 140, one or more input devices 150 and one or more output devices 160.

In some embodiments, the computing device 100 can be implemented as various user terminals or service terminals having the computing capability. The service terminals can be servers, large-scale computing devices, and the like provided by a variety of service providers. The user terminal may be, for example, a mobile terminal, a fixed terminal, or a portable terminal of any type, including a mobile phone, a site, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combinations thereof, including accessories and peripherals of these devices or any other combinations thereof. It can also be appreciated that the computing device 100 can support any type of user-specific interfaces (such as “wearable” circuits and the like).

The processing unit 110 can be a physical or virtual processor and can execute various processing based on the programs stored in the memory 120. In a multi-processor system, a plurality of processing units executes computer-executable instructions in parallel to enhance the parallel processing capability of the computing device 100. The processing unit 110 also can be referred to as the central processing unit (CPU), graphic processing unit (GPU), microprocessor, controller, and microcontroller.

The computing device 100 usually includes a plurality of computer storage media. Such media can be any media accessible by the computing device 100, including but not limited to volatile and non-volatile media, removable and non-removable media. The memory 120 can be a volatile memory (e.g., register, cache, Random Access Memory (RAM)), a non-volatile memory (such as Read-Only Memory (ROM), Electrically Erasable Programmable Read-Only Memory (EEPROM), flash), or any combinations thereof. The memory 120 can include a channel-wised codec 122 implemented as a program module, the channel-wised codec 122 being configured as a program module that executes the function of generating images from texts as described herein. The channel-wised codec 122 can be accessed and run by the processing unit 110 to perform corresponding functions. Alternatively or additionally, the channel-wised codec 122 may be implemented in hardware-based circuitry, such as application specific integrated circuit (ASIC).

The storage device 130 can be a removable or non-removable medium and may include a machine-readable medium, which may be used for storing information and/or data and may be accessed within the computing device 100. The computing device 100 may include a further removable/non-removable, volatile/non-volatile storage medium. Although not shown in FIG. 1, there can be provided a disk drive for reading from or writing into a removable and non-volatile disk and an optical disk drive for reading from or writing into a removable and non-volatile optical disk. In such cases, each drive can be connected to a bus (not shown) via one or more data medium interfaces.

The communication unit 140 enables communication with another computing device through communication media. Additionally, functions of components of the computing device 100 may be realized by a single computer cluster or multiple computing machines, and these computing machines may communicate with each other through communication connections. Therefore, the computing device 100 may operate in a networked environment using a logic connection to one or more other servers, a Personal Computer (PC), or a further general network node.

The input device 150 may be one or more various input devices, such as a mouse, a keyboard, a trackball, a voice-input device, and the like. The output device 160 may be one or more output devices, e.g., a display, a loudspeaker, a printer, etc. The computing device 100 also may communicate through the communication unit 140 with one or more external devices (not shown) as required, wherein the external devices, e.g., storage devices, display devices, etc., communicate with one or more devices that enable the users to interact with the computing device 100, or with any devices (such as network card, modem and the like) that enable the computing device 100 to communicate with one or more other computing devices. Such communication can be implemented via Input/Output (I/O) interfaces (not shown).

In some embodiments, apart from being integrated on an individual device, some or all of the respective components of the computing device 100 may be set in the form of cloud computing architecture. In the cloud computing architecture, these components may be remotely arranged and may cooperate in implementing the functions described by the disclosure. In some embodiments, the cloud computing provides computation, software, data access, and storage services without a terminal user being aware of physical positions or configurations of systems or hardware providing such services. In various embodiments, the cloud computing provides services via Wide Area Network (such as the Internet) using suitable protocols. For example, the cloud computing provider provides, via the Wide Area Network, the applications, which may be accessed through a web browser or any other computing components. Software or components of the cloud computing architecture and corresponding data may be stored on a server at a remote position. The computing resources in the cloud computing environment may be merged or spread at a remote data center. The cloud computing infrastructure may provide, via a shared data center, the services even though they are shown as a single access point for the user. Therefore, components and functions described herein may be provided using the cloud computing architecture from a service provider at a remote position. Alternatively, components and functions may be provided from a conventional server, or they may be mounted on a client device directly or in other ways.

According to various embodiments of the disclosure, the computing device 100 may encode an image into a bitstream using the channel-wised codec 122 as an encoder. As shown in FIG. 1, the computing device 100 may receive an input image 170-1 from the input device 150. Alternatively, the computing device 100 also may read from the storage device 130 the input image 170-1, or receive via the communication device 140 the input image 170-1 from other devices. The computing device 100 may transmit the input image 170-1 to the channel-wised codec 122. The channel-wised codec 122 encodes the input image 170-1 and generates an output bitstream 180-1 including the encoded image.

When encoding the input image 170-1, the channel-wised codec 122 may divide the input image 170-1 to generate channels. The channels refer to parts or components of the image which may be used to reconstruct the image by inverse operation(s) of the division. The channel-wised codec 122 may perform transform operation(s) on the image to divide the image. For example, wavelet transform may be applied to obtain subbands as the channels. In some embodiments, the channel-wised codec 122 may perform division operations on the image and at least a portion of the division results repeatedly to obtain multiple layers of channels, each layer including multiple channels. By transform operations on the image, the obtained channels may have coefficients in the corresponding domain (e.g. frequency domain, wavelet domain, and the like), and the coefficients may be further quantized for encoding. The channel-wised codec 122 then encodes the first one of the channels based on entropy encoding with a predefined frequency table. The channel-wised codec 122 may further obtain entropy parameter(s) of the first channel, and predict the entropy parameter(s) of the remaining channels based on the entropy parameter(s) of the first channel. The channel-wised codec 122 may encode the remaining channels with predicted entropy parameter(s) for the corresponding channels. The channel-wised codec 122 may transmit the encoded channels and generate the bitstream 180-1 as output.

According to various embodiments of the disclosure, the computing device 100 may decode a bitstream to obtain a reconstructed image using the channel-wised codec 122 as a decoder. As shown in FIG. 1, the computing device 100 may receive an input bitstream 170-2 from the input device 150. Alternatively, the computing device 100 also may read from the storage device 130 the bitstream 170-2, or receive via the communication device 140 the bitstream 170-2 from other devices. The computing device 100 may transmit the bitstream 170-2 to the channel-wised codec 122. The channel-wised codec 122 decodes the bitstream 170-2 and outputs a reconstructed image 180-2.

When decoding the bitstream 170-2, the channel-wised codec 122 may extract and decode the first channel in the received bitstream using the predefined frequency table as encoding. The channel-wised codec 122 may further obtain entropy parameter(s) of the first channel, and predict the entropy parameter(s) of the remaining channels based on the entropy parameter(s) of the first channel. The channel-wised codec 122 may decode the remaining channels with predicted entropy parameter(s) for the corresponding channels. By doing this, the channel-wised codec 122 may obtain the reconstructed image 180-2 as output.

In FIG. 1, it is illustrated that both of the encoding and decoding operations are implemented by the channel-wised codec 122. It will be appreciated that the encoding and decoding operations may be implemented by separate components of the computing device 100 or by different computing devices as long as they comprise the encoding or decoding components as proposed in the present disclosure. It is to be understood that the architecture and functions in the environment 100 are described for illustrative purposes only without suggesting any limitations. There may also be other devices, systems, or components that are not shown in the environment 100. Furthermore, embodiments of the present disclosure may also be applied to other environments having different structures and/or functions.

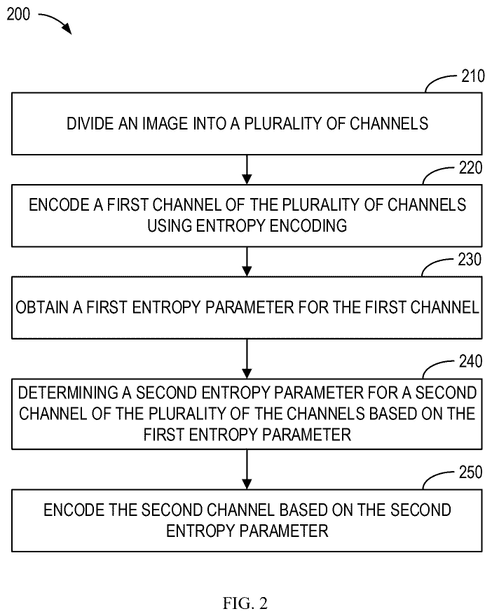

FIG. 2 illustrates a flowchart of an example method 200 for encoding an image according to some embodiments of the present disclosure. The method 200, for example, may be implemented by the computing device 100, shown in FIG. 1. More specifically, the method 200 may be implemented by the channel-wised codec 122 in FIG. 1. It should be understood that the method 200 may include additional acts not shown and/or omit the illustrated acts. The scope of the disclosure is not limited in this regard. The method 200 will be described from the perspective of view of the computing device 100.

At block 210, the computing device 100 divides an image into a plurality of channels. The computing device 100 may, upon reception of an input image 170-1, perform transform operations on the input image 170-1 and converts it onto a different domain, for example, frequency domain, wavelet domain, and etc. The computing device 100 may then divide the transformed image into channels. Alternatively, the computing device 100 may directly divide the input image in the spatial domain in view of the pixels.

In some embodiments, the computing device 100 may divide the image into multiple layers, and further divide each of the multiple layers into multiple channels to obtain the plurality of channels of the image. The layers may refer to different levels of transpose operation. For example, the computing device 100 may firstly divide the original image to obtain channels at layer 1, and further divide one or more of the channels at layer 1 to obtain channels at layer 2, and so on. By repetition of the division operations, the obtained channels of the image may be hierarchical.

In some embodiments, the computing device 100 may apply a wavelet transform to divide the image or a channel of the image to generate wavelet subbands as the channels. In some embodiments, the computing device 100 may perform a wavelet transform to obtain subbands at layer 1, and perform a further wavelet transform on one of the subbands at layer 1 to obtain subbands at layer 2.

In some embodiments, each of the channels may comprise coefficients in a corresponding domain. The computing device 100 may further quantize the coefficients of the channels. The encoding of the image will target the quantized coefficients of the channels.

At block 220, the computing device 100 encodes a first channel of the plurality of channels based on entropy encoding. When there is only one layer, the first channel may be any one of the channels. When there are multiple layers, the first channel may be a channel located at a highest layer of the multiple layers. That is, the encoding of channels starts from the highest layer, and then moves to lower layers one by one, until all channels are encoded. In some embodiments, the computing device 100 may encode the first channel based on a predefined frequency table. The frequency table may be fixed.

At block 230, the computing device 100 obtains a first entropy parameter for the first channel. The entropy parameter may indicate a probabilistic distribution of the related source data. In some embodiments, the first entropy parameter may indicate a probabilistic distribution of the quantized coefficients of the first channel. For example, the probabilistic distribution may be a Gaussian distribution. In this case, the first entropy parameter may include a mean and/or a variance of the Gaussian distribution. Other probabilistic distributions of the quantized coefficients are also applicable, and the entropy parameter may vary accordingly.

The computing device 100 may obtain the first entropy parameter for the first channel based on a machine learning method. In some embodiments, the computing device 100 may use a neural network to obtain the first channel. The neural network receives the coefficients of the first channel as input, analyses the distribution of the coefficients, and outputs the first entropy parameter. The neural network may comprise a deep convolution neural network (CNN). As an example, the neural network may be special Mu-Signal neural network (MSNet).

At block 240, the computing device 100 determines a second entropy parameter for a second channel of the plurality of the channels based on the first entropy parameter. The computing device 100 may use a second neural network to predict the second entropy parameter for the second channel from the first entropy parameter. The second neural network receives the first entropy parameter and predicts the second entropy parameter as output. As an example, the second neural network for inter channel prediction may be Context Mu-Signal neural network (CMSNet). The predicted entropy parameter may indicate the probabilistic distribution of the quantized coefficients of the second channel.

In some embodiments, the inter channel prediction of the entropy parameter at block 240 may be applicable to channels at a same layer. The reason may be that such channels are generated from a same channel at a lower layer. The underlying relationship of coefficients between those channels could be utilized for prediction.

At block 250, the computing device 100 encodes the second channel based on the second entropy parameter. As mentioned, the second entropy parameter indicates the probabilistic distribution of coefficients of the second channel, the computing device 100 may use this information to encode the second channel based on entropy encoding. For example, the computing device 100 may generate a frequency table of the coefficients based on the second entropy parameter for the second channel, and encode the second channel according to the generated frequency table.

In some embodiments, the computing device 100 may use previous channels entropy parameters to predict the next channel entropy parameter. It may use entropy parameters of one or more previous channels to predict the entropy parameter of another channel. In some embodiments, if there is a third channel applicable for inter channel prediction (i.e. at the same layer), the computing device 100 may predict a third entropy parameter for the third channel based on the first entropy parameter and the second entropy parameter, and encode the third channel based on the third entropy parameter. Alternatively, the computing device 100 may use the instant entropy parameter solely to predict for the next channel.

The computing device 100 may continue the inter channel prediction until all of the channel at the current layer are encoded. Then, the computing device 100 may move to the next lower level and repeat operations 230 to 250, until finally all channels are encoded.

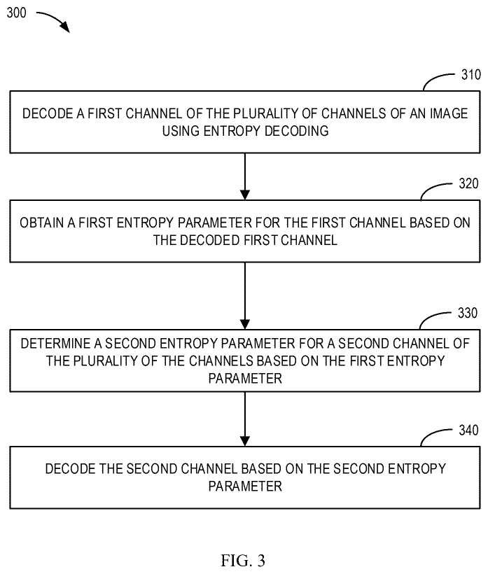

FIG. 3 illustrates a flowchart of an example method 300 for decoding an image according to some embodiments of the present disclosure. The method 300, for example, may be implemented by the computing device 100, shown in FIG. 1. More specifically, the method 300 may be implemented by the channel-wised codec 122 in FIG. 1. It should be understood that the method 300 may include additional acts not shown and/or omit the illustrated acts. The scope of the disclosure is not limited in this regard. The method 300 will be described from the perspective of view of the computing device 100.

At block 310, the computing device 100 decodes a first channel of a plurality of an image based on entropy decoding. The computing device 100 may receive a bitstream 170-2, and start decoding from the first channel which is encoded in the bitstream 170-2. When there is only one layer, the first channel may be any one of the channels as encoded. When there are multiple layers, the first channel may be a channel located at a highest layer of the multiple layers. The decoding starts from the highest layer, and then moves to lower layers one by one, until all channels are decoded. In some embodiments, the computing device 100 may decode the first channel based on a predefined frequency table as used at the encoding stage.

At block 320, the computing device 100 obtains a first entropy parameter for the first channel. After obtaining the decoded first channel, the computing device may obtain the first entropy parameter for the first channel. As mentioned, the entropy parameter may indicate a probabilistic distribution of source data. The first entropy parameter may indicate a probabilistic distribution of the quantized coefficients of the first channel. For example, the probabilistic distribution may be a Gaussian distribution. In this case, the first entropy parameter may include a mean and a variance of the Gaussian distribution.

The computing device 100 may obtain the first entropy parameter in the same way as at encoding stage. It may use the same neural network (for example, the MSNet) to the decoded first channel in order to obtain the first entropy parameter.

At block 330, the computing device 100 determines a second entropy parameter for a second channel of the plurality of the channels based on the first entropy parameter. The computing device 100 may use a second neural network, the same one at the encoding stage (for example, the CMSNet), to predict the second entropy parameter for the second channel from the first entropy parameter. The predicted entropy parameter for the second channel may indicate the probabilistic distribution of the quantized coefficients of the second channel.

In some embodiments, the inter channel prediction of the entropy parameter may applicable to channels at a same layer. As discussed, since channels at the same layer may be generated from a same channel at a lower layer, their coefficients are thus related and can be predicted by the machine learning method.

At block 340, the computing device 100 decodes the second channel based on the second entropy parameter. As mentioned, the second entropy parameter indicates the probabilistic distribution of coefficients of the second channel, the computing device 100 may use this information to decode the second channel based on entropy decoding. For example, the computing device 100 may generate a frequency table of the coefficients based on the entropy parameter for the second channel, and decode the second channel according to the frequency table.

The computing device 100 may further use previous channels entropy parameters to predict the next channel entropy parameter. It may use entropy parameters of one or more previous channels to predict the entropy parameter of another channel. In some embodiments, if there is a third channel applicable for inter channel prediction (i.e. at the same layer), the computing device 100 may predict a third entropy parameter for the third channel based on the first entropy parameter and the second entropy parameter, and decode the third channel based on the third entropy parameter. Alternatively, the computing device 100 may use the instant entropy parameter solely to predict for the next channel. The computing device 100 may continue the inter channel prediction until all of the channel at the current layer are encoded.

In some embodiments, the computing device 100 may implement inter layer prediction of the entropy parameters. When all of channels at the current layer are decoded, the computing device 100 may calculate a corresponding channel at a next lower layer based on the decoded channels at the current layer. As an example, if the channels at a higher layer are generated by image transform operation on a lower layer, the computing device 100 may calculate the corresponding channel at the lower layer by an inverse transform operation. As such, the computing device 100 obtains the decoded first channel at the lower layer without actual entropy decoding, and the decoding moves the next lower layer. Then, the operations 320 to 340 are repeated, until finally all channels at layer 1 are decoded. The computing device 100 may perform an inversion transform of channel division on the decoded channels at layer 1, and dequantize the result of the inversion transform to reconstruct the image.

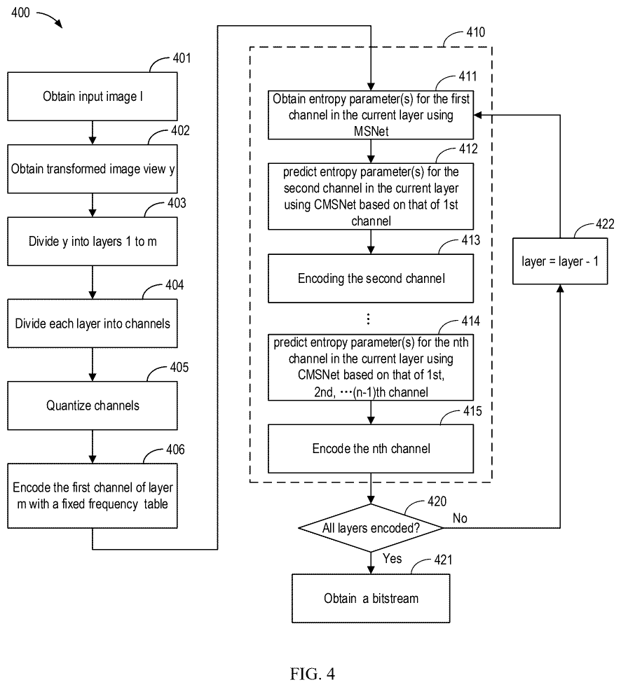

FIG. 4 illustrates a flowchart of another example method 400 for encoding an image according to some embodiments of the present disclosure. The method 400, for example, may be implemented by the computing device 100, shown in FIG. 1. The method 400 is an embodiment of the method 200.

At block 401, the computing device 100 obtains an input image I. At block 402, the computing device 100 may obtain a transformed image view y of the input image I. For example, it may convert the input image I onto a frequency domain, and the image is therefore represented by a set of coefficients of frequencies instead of pixel values.

At block 403, the computing device 100 may divide the transformed image view y into multiple layers, say layer 1, layer 2 . . . layer m. At block 404, the computing device 100 may further divide each layer into multiple channels. Note that a number of the channels may be different for the layers. At block 405, the computing device 100 may quantize the channels.

At block 406, the computing device 100 may encode the first channel of the layer m, i.e. the highest layer, with a fixed frequency table. The computing device 100 may assign a code to each of the coefficients of the channel based on the frequency table, and encode the channel according to a entropy method, for example, Huffman coding, arithmetic coding, and the like.

At block 410, the computing device 100 may encode the channels layer by layer. It may start from the highest layer m. For each layer, the computing device 100 encodes the channels based on inter channel prediction of entropy parameters. In particular, at block 411, the computing device 100 may obtain entropy parameter(s) for the first channel in the current layer using a machine learning method, e.g. the MSNet. At block 412, the computing device 100 may predict entropy parameter(s) for the second channel in the currently layer using CMSNet based on the entropy parameter(s) of the first channel. With the predicted entropy parameter(s) for the second channel, the computing device 100 at block 413 encodes the second channel according to entropy encoding.

The computing device 100 may predict entropy parameter(s) of the remaining channels in the current layer in a similar way. In some embodiments, the computing device may use entropy parameters of the previous channels to predict for the next channel. As shown, at block 414, the computing device 100 may predict entropy parameter(s) for the nth channel (the last one) in the layer using CMSNet based on the entropy parameter(s) of the first, the second . . . and the (n−1)th channels. At block 415, the computing device 100 encodes the nth channel with the predicted entropy parameter(s).

Next, at block 420, the computing device 100 determines whether all layers are encoded. If no, the method 400 proceeds to block 422, where the current layer is changed to the next lower layer. The computing device 100 may repeat the actions in blocks 411 to 415 to encode the channels at the next lower layer. If all layers have been encoded, the method 400 proceeds to block 421, the computing device 100 may obtain a bitstream including the encoded channels of the image.

The method 400 may be represented by the following pseudo code of an encoder according to embodiments of the disclosure.

Encoder

```
▪ Obtain input image l
▪ Receive transformed image view y
▪ Divide y into layers: lᵢ ... lₘ
▪  $Divide each layer {l}_{i} into channels \text{:} {y}_{i}^{1} … {y}_{i}^{n}$
▪  $Quantize {y}_{i}^{j} to$
▪  $Transmit entropy encoded \hat{{y}_{1}^{m}} with fixed frequencies table f$
▪ For each layer lᵢ in lₘ ... l₁ do:
    •  $Apply MSNet to obtain {p}_{1}^{i} entropy parameters for \hat{{y}_{1}^{i}}$
    •  $Apply CMSNet used {p}_{1}^{i} as input to predict {p}_{2}^{i} entropy$
        $parameters for \hat{{y}_{2}^{i}}$
    •  $Encode \hat{{y}_{2}^{i}} with {p}_{2}^{i} and transmit to bitstream$
    • . . .
    •  $Apply CMSNet used {p}_{1}^{i} … {p}_{n - 1}^{i} to predict {p}_{n}^{i} entropy$
        $parameters for \hat{{y}_{n}^{i}}$
    •  $Encode \hat{{y}_{n}^{i}} with {p}_{n}^{i} and transmit to bitstream$
```

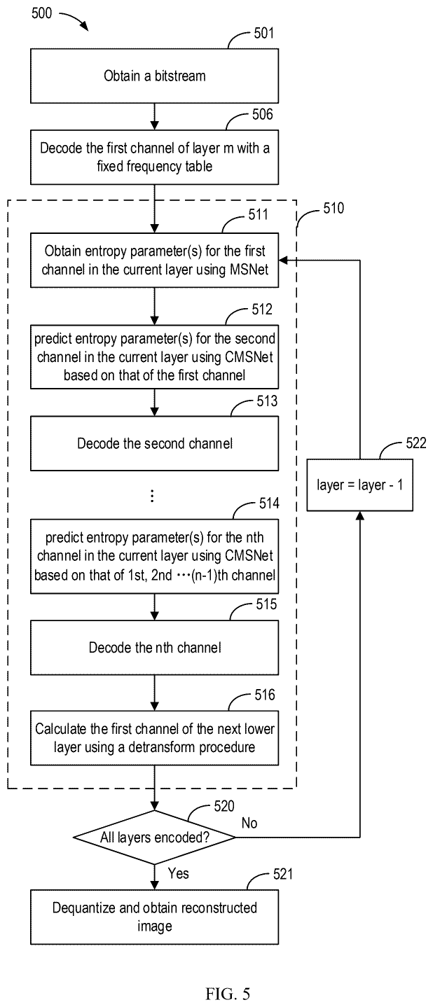

FIG. 5 illustrates a flowchart of another example method 500 for decoding an image according to some embodiments of the present disclosure. The method 500, for example, may be implemented by the computing device 100, shown in FIG. 1. The method 500 is an embodiment of the method 300.

At block 501, the computing device 100 obtains a bitstream. At block 506, the computing device 100 may decode the first channel of layer m, i.e. the highest layer, with a fixed frequency table.

At block 510, the computing device 100 may decode the channels layer by layer. It may start from the highest layer m. For each layer, the computing device 100 decodes the channels based on inter channel prediction of entropy parameters. In particular, at block 511, the computing device 100 may obtain entropy parameter(s) for the first channel in the current layer using a machine learning method, e.g. the MSNet. At block 512, the computing device 100 may predict entropy parameter(s) for the second channel in the currently layer using CMSNet based on the entropy parameter(s) of the first channel. With the predicted entropy parameter(s) for the second channel, the computing device 100 at block 513 decodes the second channel according to entropy encoding.

The computing device 100 may predict entropy parameter(s) of the remaining channels in the current layer in a similar way. In some embodiments, the computing device may use entropy parameters of the previous channels to predict for the next channel. As shown, at block 514, the computing device 100 may predict entropy parameter(s) for the nth channel (the last one) in the layer using CMSNet based on the entropy parameter(s) of the first, the second . . . and the (n−1)th channels. At block 415, the computing device 100 decodes the nth channel with the predicted entropy parameter(s).

At block 516, the computing device 100 may calculate the first channel of the next lower lay using a detransform procedure. As the channels at the current layer are generated from a channel at an adjacent lower layer, the computing device may derive the channel at the lower layer by detranforming the decoded channels at the current layer. In this way, inter layer decoding of channels can be achieved, and the frequency table is only needed for the first channel at the highest layer.

Next, at block 520, the computing device 100 determines whether all layers are decoded. If no, the method 500 proceeds to block 522, where the current layer is changed to the next lower layer. The computing device 100 may repeat the actions in blocks 511 to 516 to decode the channels at the next lower layer. If all layers have been decoded, the method 500 proceeds to block 521, the computing device 100 may dequantize and obtain a reconstructed image.

The method 500 may be represented by the following pseudo code of a decoder according to embodiments of the disclosure.

Decoder

```
▪ Decode [symbol]  with received from bitstream fixed frequencies table f
▪ For each layer lᵢ in lₘ ... l₁ do:
    •  $Apply MSNet to obtain {p}_{1}^{i} entropy parameters for$
    •  $Apply CMSNet used {p}_{1}^{i} as input to predict {p}_{2}^{i} entropy$
        parameters for [symbol]
    •  $Decode received from bitstream encoded with {p}_{2}^{i}$
    • . . .
    •  $Apply CMSNet used {p}_{1}^{i} … {p}_{n - 1}^{i} to predict {p}_{n}^{i} entropy$
        parameters for [symbol]
    •  $Decode received from bitstream endoced with {p}_{n}^{i}$
    • Calculate [symbol] , using detransform procedure
▪ Dequntized [symbol]
▪ Obtain reconstructed image
```

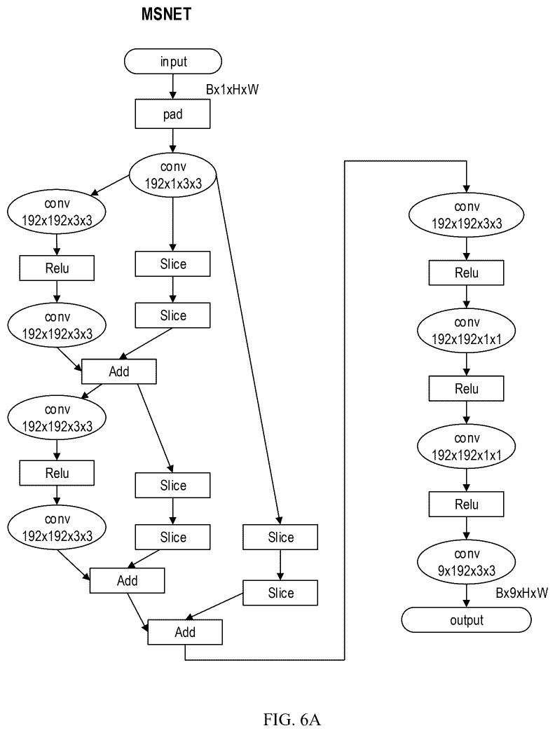

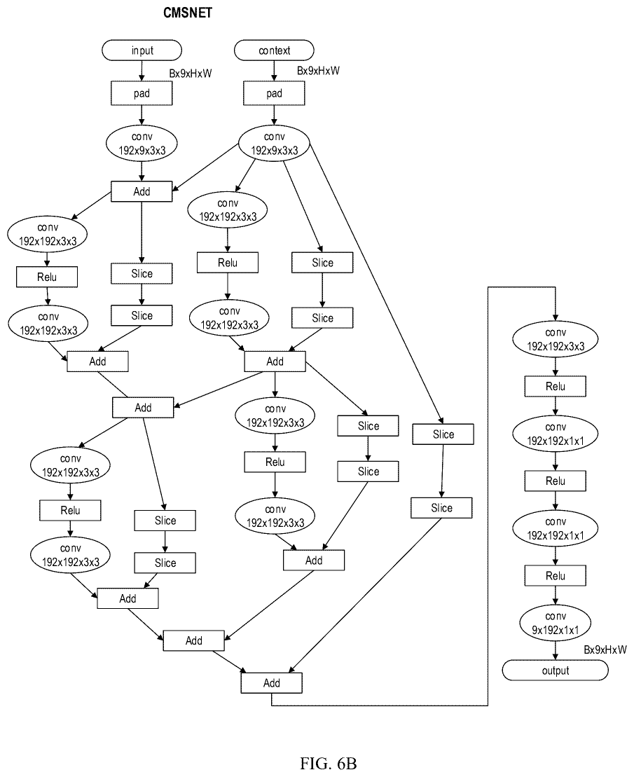

FIG. 6A illustrates a schematic diagram of an example neutral network for determining entropy parameters from a quantized channel according to some embodiments of the present disclosure. The network as shown may be an embodiment of an MSNet. It receives coefficients of the channel, applies for each coefficient of the channel a 3×3 window, and gets adaptive template as output. The output may be considered as entropy parameter for the input channel.

FIG. 6B illustrates a schematic diagram of an example neutral network for inter-channel prediction of entropy parameters according to some embodiments of the present disclosure. The network as shown may be an embodiment of an CMSNet. It receives input from the MSNet, combines it with the context, and generates the entropy parameter for the next channel as prediction results.

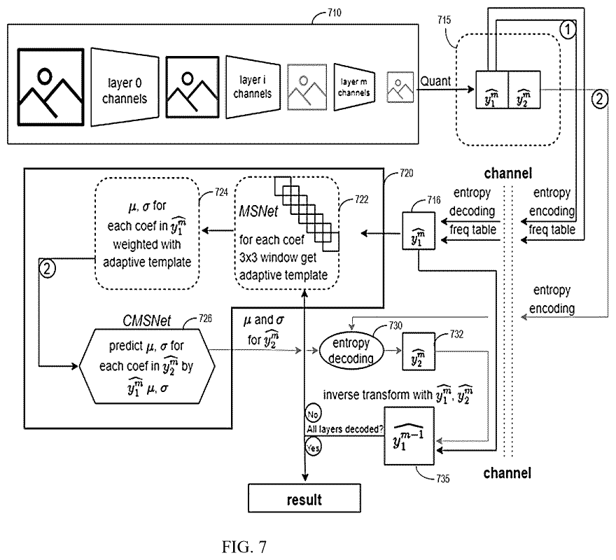

FIG. 7 illustrates a schematic diagram of an example decoding flow according to some embodiments of the present disclosure. The decoding flow as shown may be implemented by the computing device 100, shown in FIG. 1. It is to be understood that a corresponding encoding flow may be implemented by the computing device 100 or other devices.

At block 710, an image is divided into layer 0, layer 1 . . . layer m, each layer including multiple channels. The channels of the input image are then quantized. For simplicity, two quantized channels of the highest layer m are shown at block 715. It is to be understood that the layer m may have more channels. Also for simplicity, data at the block 715 may also represents an encoded image in form of a bitstream.

When decoding, the computing device 100 may firstly decode the first quantized channel with a fixed frequency table, and obtain the decoded first channel 716 at layer m. The computing device 100 may provide the decoded first channel 716 to the inter channel prediction module 720. As shown, the MSNnet 722 receives the decoded first channel 716 and generates entropy parameters 724 of the first channel 716. The entropy parameters 724 comprise a mean and a variance for each coefficient in the channel, where the coefficient is assumed to satisfy a Gaussian distribution.

The computing device 100 further provides the entropy parameters of the first channel 716 to the CMSNet 726, which predicts the entropy parameters of the second channel. The predicted entropy parameters are provided to the entropy decoding module 730, and the decoded second channel 732 is obtained accordingly. It is to be understood that the inter channel prediction module 720 may comprise more CMSNets 726 for additional channels in the layer.

After all channels in the layer m are decoded, the computing device 100 may perform inverse transform with decoded channels to obtain the first channel 735 at the next lower layer m−1. The channel 735 is then provided to the inter channel prediction module 720. Therefore, the computing device 100 starts to decode the channels at layer m−1. This process may be repeated until all layers are decoded. The computing device 100 obtains the reconstructed image as the decoding result.

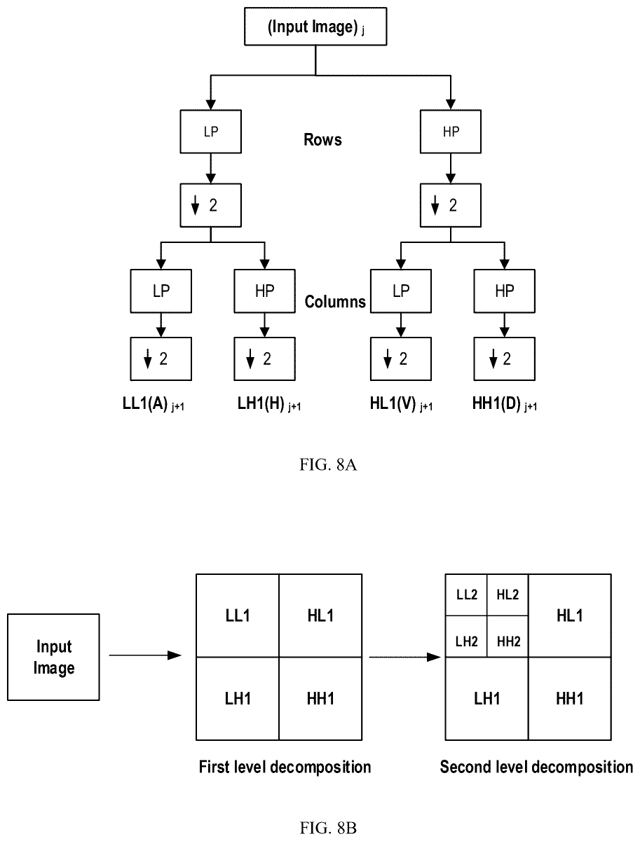

In some embodiments, wavelet transform may be applied to divide an image into multiple layers of channels. FIG. 8A illustrates an example wavelet transform for an image according to some embodiments of the present disclosure. As shown, in one wavelet transform, a low pass filter (LP) and a high pass filter (HP) may be applied horizontally and vertically in combination to divide an input image at layer j to subbands LL1 (A), LH1 (H), HL1(V), and HH1(D) at layer j+1. Here, A stands for Approximation coefficients, and H, V, D stand for Horizontal, Vertical, and Diagonal detail coefficients respectively. In this way, the image may be decomposed into multiple layers of subbands.

FIG. 8B illustrates an example decomposition of an image based on the wavelet transform as shown in FIG. 8A according to some embodiments of the present disclosure. In FIG. 8B, subbands after two layers or levels of wavelet decomposition are shown.

The wavelet decomposition of an image is carried out as follows: In the first level of decomposition, the image is split into 4 subbands, e.g., the HH, HL, LH and LL subbands. The HH subband gives the diagonal details of the image; the HL and LH subbands give the horizontal and vertical features respectively. In FIG. 8B, the subbands at the first levels, the second level and so on (if any) are examples of the channels according to embodiments of the disclosure.

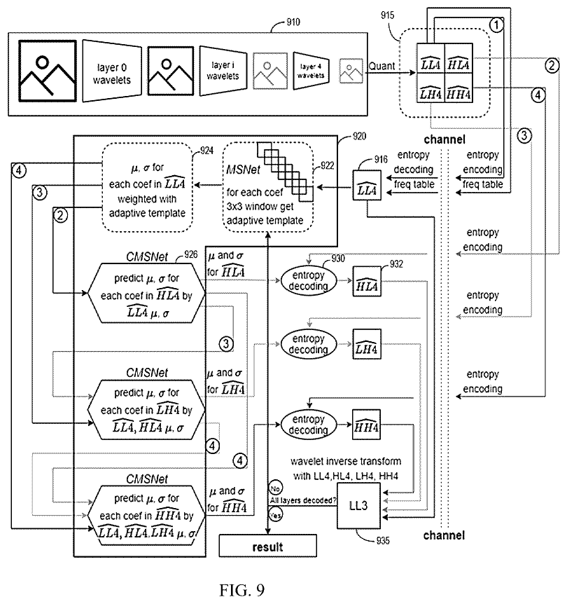

FIG. 9 illustrates a schematic diagram of another example decoding flow according to some embodiments of the present disclosure. The decoding flow as shown may be implemented by the computing device 100, shown in FIG. 1. It is to be understood that a corresponding encoding flow may be implemented by the computing device 100 or other devices.

At block 910, the image has been divided into multiple layers of subbands (i.e. channels) based on wavelet transform as discussed with reference to FIGS. 8A and 8B. In FIG. 9, there are four layer of subbands, and the layer 4 915 comprises quantized subbands [symbol] , [symbol] , [symbol] , and [symbol] .

When decoding, the computing device 100 may firstly decode the [symbol] subband 916 with a fixed frequency table, and obtain the decoded [symbol] subband 916. The computing device 100 may provide the decoded [symbol] subband 916 to the inter channel prediction module 920. As shown, the MSNnet 722 receives the decoded [symbol] subband 916 and generates entropy parameters 924 for the [symbol] subband 916.

The computing device 100 further provides the entropy parameters 924 for the [symbol] subband 916 to the CMSNet 926, which predicts the entropy parameters for the [symbol] subband. The predicted entropy parameters are provided to the entropy decoding module 930, and the decoded [symbol] subband 932 is obtained accordingly. In the inter channel prediction module 920, the entropy parameters of the [symbol] and [symbol] subbands are further provided to the CMSNet to predict the entropy parameters of the [symbol] subband. The [symbol] subband is then decoded based on its predicted entropy parameters. Furthermore, the [symbol] subband is also decoded based on the prediction with the entropy parameters for previous [symbol] , [symbol] , [symbol] subbands.

After all subbands [symbol] , [symbol] , [symbol] , and [symbol] at the layer 4 are decoded, the computing device 100 may perform wavelet inverse transform with decoded subbands to obtain the [symbol] subband 935 at layer 3. The [symbol] subband 935 is then provided to the inter channel prediction module 920. Therefore, the computing device 100 starts to decode subbands at layer 3. This process may be repeated until all layers are decoded. The computing device 100 obtains the reconstructed image as the decoding result.

The proposed solution may reduce time of decoding significantly compared with a pixel-wised model as baseline. Possible experimental results can be connected with amount of decoding time for autoregression in pixel-wised case: <number of pixels>*<time of decoding one symbol> and amount of decoding time for autoregression in channel-wise case: <number of channels>*<time of decoding one symbol>.

If the image has size of W×H (W is width, H is height) and TP seconds is time of auto regression pixel-wise model inference than time of decoding will be W×H×TP seconds. If C is count of channel and TC seconds is time of channel-wise model inference than time of decoding will be C×TC seconds. It is observed that that C<<W×H and TC˜TP, so decoding time of channel-wise model much lower than decoding time of pixel-wise model.

For example, in one Full-HD image there are about 2,000,000 pixels. With wavelet decomposition with 4 layers, there are only 13 channels. Therefore, the difference in decoding time is ˜150.000 times (2,000,000/13) if both models have similar inference time (this means that TC˜TP). Thus, the proposed solution allows to significantly reduce the decoding time.

In some embodiments, an apparatus capable of performing the method 200 (for example, the computing device 100) may comprise means for performing the respective operations of the method 200. The means may be implemented in any suitable form. For example, the means may be implemented in a hardware circuitry or a software module.

In some embodiments, the apparatus comprises means for dividing an image into a plurality of channels; means for encoding a first channel of the plurality of channels based on entropy encoding; means for obtaining a first entropy parameter for the first channel; means for determining a second entropy parameter for a second channel of the plurality of the channels based on the first entropy parameter; and means for encoding the second channel based on the second entropy parameter.

In some embodiments, means for dividing an image into a plurality of channels may comprise means for dividing the image into multiple layers; and means for dividing each of the multiple layers into multiple channels to obtain the plurality of channels of the image.

In some embodiments, the first channel may be located at a highest layer of the multiple layers and may be encoded based on a predefined frequency table.

In some embodiments, means for dividing an image into a plurality of channels may comprise means for performing at least one wavelet transform operation on the image to generate a plurality of wavelet transform subbands as the plurality of channels.

In some embodiments, the first channel and the second channel may be located at a same layer.

In some embodiments, the apparatus may further comprise means for determining a third entropy parameter for a third channel of the plurality of the channels based on the first entropy parameter and the second entropy parameter; and means for encoding the third channel based on the third entropy parameter.

In some embodiments, means for obtaining a first entropy parameter for a first channel may comprises means for obtaining the first entropy parameter based on a first neural network with the encoded first channel as input.

In some embodiments, means for determining second entropy parameter for a second channel may comprise means for obtaining the second entropy parameter based on a second neural network with the first entropy parameter as input.

In some embodiments, each of the plurality of channels may comprise quantized coefficients.

In some embodiments, the first entropy parameter may indicate a probabilistic distribution of the quantized coefficients of the first channel.

In some embodiments, the probabilistic distribution may be a Gaussian distribution, and the first entropy parameter may comprise one or more of a mean or a variance of the Gaussian distribution.

In some embodiments, the apparatus further comprises means for performing other operations in some embodiments of the method 200. In some embodiments, the means comprises at least one processor and at least one memory including computer program code, the at least one memory and computer program code configured to, with the at least one processor, cause the performance of the apparatus.

In some embodiments, an apparatus capable of performing the method 300 (for example, the computing device 100) may comprise means for performing the respective operations of the method 300. The means may be implemented in any suitable form. For example, the means may be implemented in a hardware circuitry or a software module.

In some embodiments, the apparatus comprises means for decoding a first channel of a plurality of channels of an image based on entropy decoding; means for obtaining a first entropy parameter for the first channel based on the decoded first channel; means for determining a second entropy parameter of a second channel for the plurality of the channels based on the first entropy parameter; and means for decoding the second channel based on the second entropy parameter.

In some embodiments, the plurality of channels may comprise multiple layers of channels, each of the multiple layers comprising multiple channels. In some embodiments, the first channel may be located at a highest layer of the multiple layers and may be decoded based on a predefined frequency table. In some embodiments, the first channel and the second channel may be located at a same layer.

In some embodiments, the apparatus may further comprise means for determining a third entropy parameter for a third channel of the plurality of the channels based on the first entropy parameter and the second entropy parameter and means for decoding the third channel based on the third entropy parameter.

In some embodiments, the apparatus may further comprise means for, in case that all of channels at a layer are decoded, calculating a corresponding channel at a next lower layer based on the decoded channels at the layer.

In some embodiments, the plurality of channels may comprise a plurality of wavelet transform subbands. In some embodiments, means for obtaining a first entropy parameter for a first channel may comprise means for obtaining the first entropy parameter based on a first neural network with the encoded first channel as input.

In some embodiments, means for determining second entropy parameter for a second channel may comprise means for obtaining the second entropy parameter based on a second neural network with the first entropy parameter as input.

In some embodiments, each of the plurality of channels may comprise quantized coefficients. In some embodiments, the first entropy parameter may indicate a probabilistic distribution of the quantized coefficients of the first channel. In some embodiments, the probabilistic distribution may be a Gaussian distribution, and the first entropy parameter may comprise one or more of a mean or a variance of the Gaussian distribution.

In some embodiments, the apparatus further comprises means for performing other operations in some embodiments of the method 300. In some embodiments, the means comprises at least one processor and at least one memory including computer program code, the at least one memory and computer program code configured to, with the at least one processor, cause the performance of the apparatus.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the disclosure may be written in any combination of one or more programming languages. These program codes may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine, or entirely on the remote machine or server.

In the context of this disclosure, a machine-readable medium may be any medium that may contain, or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the shown particular order or in a sequential order, or all shown operations are required to be executed to achieve the expected results. In certain circumstances, multitasking and parallel processing may be advantageous. Likewise, while several embodiment details are contained in the above discussions, these should not be construed as limitations on the scope of the disclosure described herein. Certain features that are described in the context of separate embodiments may also be implemented in combination in a single embodiment. Conversely, various features that are described in the context of a single embodiment may also be implemented in multiple embodiments separately or in any suitable sub-combination.

Although the embodiments of the disclosure have been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A method, comprising:
dividing an image into a plurality of channels;
encoding a first channel of the plurality of channels based on entropy encoding;
obtaining a first entropy parameter for the first channel;
determining a second entropy parameter for a second channel of the plurality of the channels based on the first entropy parameter; and
encoding the second channel based on the second entropy parameter.

2. The method of claim 1, wherein dividing the image into the plurality of channels comprises:
dividing the image into multiple layers; and
dividing each of the multiple layers into multiple channels to obtain the plurality of channels.

3. The method of claim 2, wherein the first channel is located at a highest layer of the multiple layers and is encoded based on a predefined frequency table.

4. The method of claim 1, wherein dividing the image into the plurality of channels comprises:
performing at least one wavelet transform operation on the image to generate a plurality of wavelet transform subbands as the plurality of the channels.

5. The method of claim 1, wherein the first channel and the second channel are located at a same layer.

6. The method of claim 1, comprising:
determining a third entropy parameter for a third channel of the plurality of the channels based on the first entropy parameter and the second entropy parameter; and
encoding the third channel based on the third entropy parameter.

7. The method of claim 1, wherein each of the plurality of channels comprises quantized coefficients;
wherein the first entropy parameter indicates a probabilistic distribution of the quantized coefficients of the first channel.

8. A method, comprising:
decoding a first channel of a plurality of channels of an image based on entropy decoding;
obtaining a first entropy parameter for the first channel based on the decoded first channel;
determining a second entropy parameter of a second channel for the plurality of the channels based on the first entropy parameter; and
decoding the second channel based on the second entropy parameter.

9. The method of claim 8, wherein the plurality of channels comprise multiple layers of channels, each of the multiple layers comprises multiple channels.

10. The method of claim 9, wherein the first channel is located at a highest layer of the multiple layers and is decoded based on a predefined frequency table.

11. The method of claim 8, comprising:
determining a third entropy parameter for a third channel of the plurality of the channels based on the first entropy parameter and the second entropy parameter; and
decoding the third channel based on the third entropy parameter.

12. The method of claim 9, further comprising:
when all of channels at a layer are decoded, calculating a corresponding channel at a next lower layer based on the decoded channels at the layer.

13. The method of claim 8, wherein the plurality of channels comprise a plurality of wavelet transform subbands.

14. The method of claim 8, wherein each of the plurality of channels comprises quantized coefficients;
wherein the first entropy parameter indicates a probabilistic distribution of the quantized coefficients of the first channel.

15. An electronic device, comprising:
a processor; and
a memory coupled to the processor and storing instructions, which when executed by the processor, cause the electronic device to:
divide an image into a plurality of channels;
encode a first channel of the plurality of channels based on entropy encoding;
obtain a first entropy parameter for the first channel;
determine a second entropy parameter for a second channel of the plurality of the channels based on the first entropy parameter; and
encode the second channel based on the second entropy parameter.

16. The electronic device of claim 15, wherein the instructions further cause the electronic device to:
divide the image into multiple layers; and
divide each of the multiple layers into multiple channels to obtain the plurality of channels.

17. The electronic device of claim 16, wherein the first channel is located at a highest layer of the multiple layers and is encoded based on a predefined frequency table.

18. The electronic device of claim 15, wherein the instructions further cause the device to:
perform at least one wavelet transform operation on the image to generate a plurality of wavelet transform subbands as the plurality of the channels.

19. The electronic device of claim 15, wherein the first channel and the second channel are located at a same layer.

20. The electronic device of claim 15, wherein the instructions further cause the device to:
determine a third entropy parameter for a third channel of the plurality of the channels based on the first entropy parameter and the second entropy parameter; and
encode the third channel based on the third entropy parameter.
